(19) United States
(12) Patent Application Publication
(10) Pub. No.: US 2014/0114739 A1
(43) Pub. Date: Apr. 24, 2014

(54) Method And System For Providing Digital Coupons in a Social Business Network

(71) Applicant: Mohammed Nazrul ISLAM, Jamaica, NY (US)

(72) Inventor: Mohammed Nazrul ISLAM, Jamaica, NY (US)

(21) Appl. No.: 14/061,583

(22) Filed: Oct. 23, 2013

Related U.S. Application Data
(60) Provisional application No. 61/717,348, filed on Oct. 23, 2012.

(51) Int. Cl. G06Q 30/02

(52) U.S. Cl. CPC G06Q 30/0239; G06Q 30/0256
USPC 705/14.39

(57) ABSTRACT

A company's coupons or advertisements can be posted on a social business network. A company needs to be registered first with the social business network before it can post its coupons and advertisements; while a consumer can view the coupons and advertisements freely with no requirement of registration. The company can either fill a coupon request form to make the network to generate a coupon for it, or create a coupon themselves and then upload it to the network. The registered company can also post its advertisement. Before anything is posted on the website, it will be reviewed to make sure its content is appropriate. The method also allows a company to purchase a time slot to use a live video screen for marketing.

The current application claims a priority to the U.S. Provisional Patent Application Ser. No. 61/717,348, filed on Oct. 23, 2012.

### FIELD OF THE INVENTION

The present invention relates generally to a method of marketing on a social business network. More specifically, it is a method and system to provide coupons and advertisements on a social business network to the consumers at various locations or ethnic markets.

### BACKGROUND OF THE INVENTION

Generally, most businesses have its targeted customers or customer groups, such as particular location(s), income range(s), culture(s) or ethnicities and so on. Instead of spending a huge amount of money to market to everyone, a more efficient way to do the marketing would be to specifically target the desired or targeted consumer groups. The foregoing is easily understandable, but traditionally, it is hard to find such a method to effectively market to a specific consumer group, such as a particular location or a particular ethnicity; and it is particularly true when the budget of a business to do such marketing is limited.

Local business is often times dominated by large corporations or national chains that have more money to fund their marketing and advertisement campaigns. While to the local business and small companies, they usually do not have enough financial resources to do such kind of large scale marketing, which are just too expensive for them. This gives a huge advantage in terms of marketing to those large corporations. And at the same time, it makes it quite tough for the local companies or small companies to compete or even just stay afloat. Yet on the other hand, it often times, just does not make sense for the local business or small companies to do such large scale advertisement and marketing as they do not anticipate that their products or services will be purchased by a major portion of the large scale audience. So, they should do business and marketing in a more efficient way; and make sure every dollar spent counts.

On the other hand, with the popularity of online social networks, more and more businesses are conducted online. Companies markets and sell products online; and the consumers search and purchase products online, too. Accordingly, the online social network provide a good opportunity for the small businesses to advertise and market online with a relatively low cost, and to more efficiently target their anticipated potential purchasers within a particular location or a particular ethnicity.

Therefore it is one objective of the present invention to provide a means for businesses to market to local and diversified markets. Using the social business network, small businesses and niche businesses can better market to their intended audience without wasting large amounts of money. The social business network also provides a more efficient and easier user experience on the customer end as they can search for local deals within specific ethnic markets. User can eliminate wasted time by searching for all local deals in one location or by the specific market or category that they desire.

### BRIEF DESCRIPTION OF THE DRAWINGS

FIG. 1 depicts the process of a company registering to the social business network of the present invention.

FIG. 2A and FIG. 2B depict the process of a registered company posting a coupon on the social network of the present invention.

FIG. 3 depicts the process of a registered company posting an advertisement on the social network of the present invention.

FIG. 4 depicts the process of a consumer to search and share a coupon on the social network of the present invention.

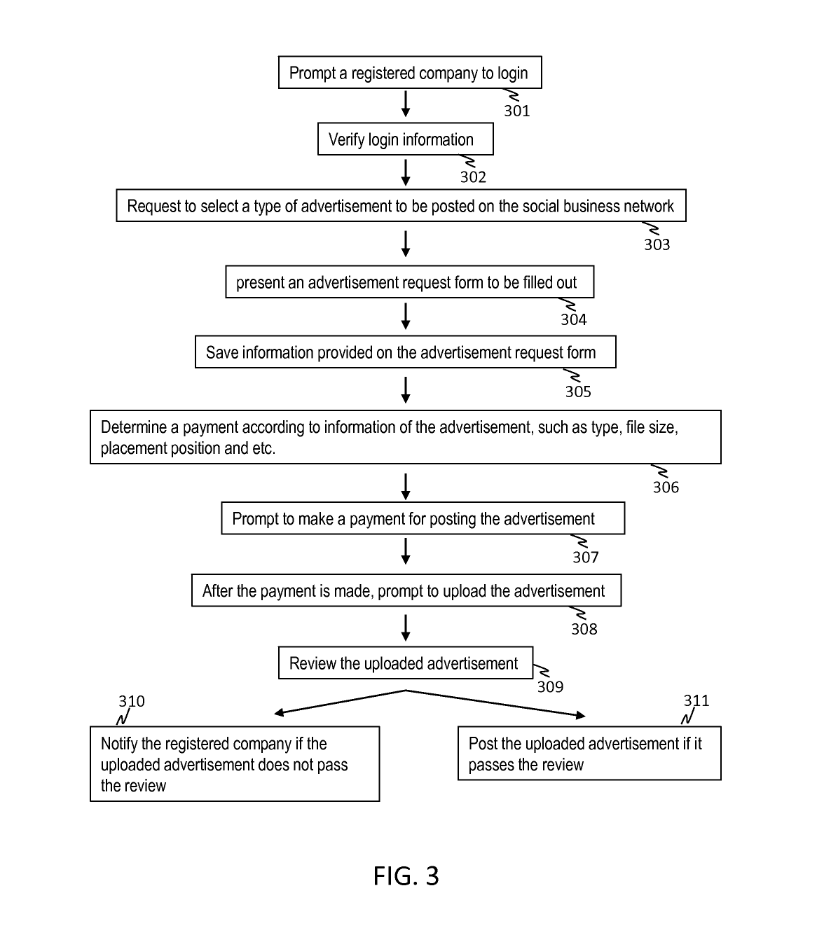

FIG. 5 depicts the live video screen provided to a company to market its product or service to consumers.

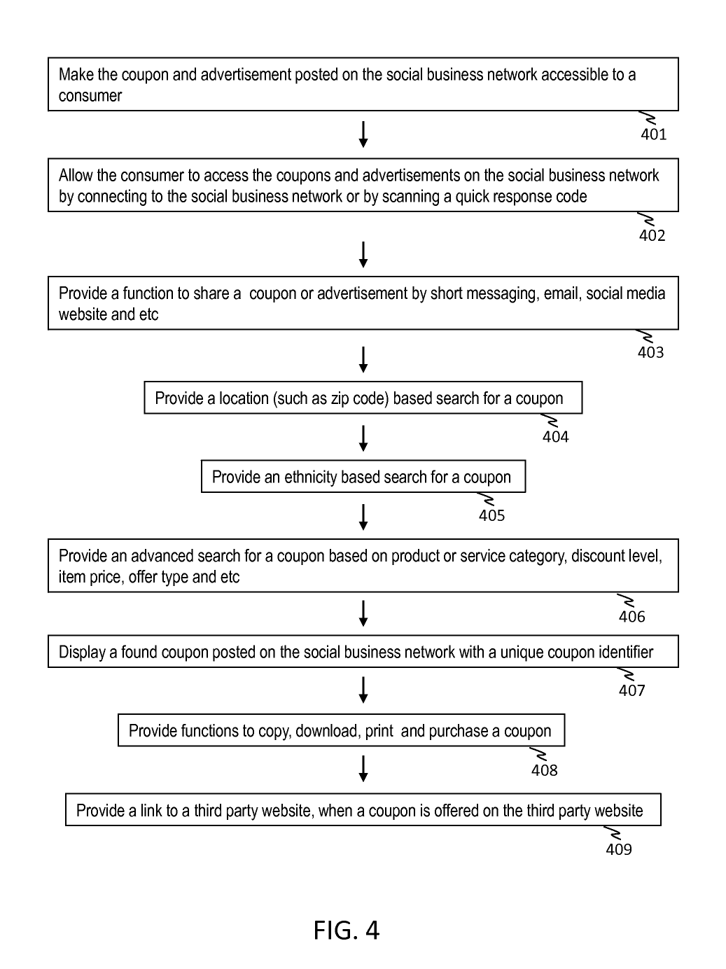

FIG. 6 shows the advanced search options that can be used to view coupons.

FIG. 7 shows various categories of coupons on the social business network.

FIG. 8 shows a sample of the ethnic markets that can be used to define a search.

FIG. 9 shows an example of a coupon generated using the coupon request form.

### DETAIL DESCRIPTIONS OF THE INVENTION

All illustrations of the drawings are for the purpose of describing selected versions of the present invention and are not intended to limit the scope of the present invention.

The present invention is an online social business network in which companies can post coupons and advertisements for their business. While companies must be registered with the social business network in order to post advertisements or coupons; customers have free access to all content and are not required to register or create an account in order to access the content on the social business network. Since everything is posted online, the social business network is available at all times of the day, to both businesses and customers. Thus both the businesses and the consumers can use the social business network at anytime convenient to them. The businesses can post and manage new or old content on this social business network at any time; and the customers can search for the best available deals at any time, too. The social business network is designed such that customers can easily search and share content with one another. The social business network is also designed to encourage the growth of local business by providing location based coupons and deals to customers. In addition to the traditional general coupons and advertisements, the content on the social business website can be categorized or searched based on particular locations or ethnicities. In this way, the marketing is performed more efficiently to the targeted potential customers.

Concerning the consumers, this social business network has provided a platform for customers whereby they can access to deals from local businesses or other resources that they are interested in. Customers can use several different search features in order to find the best deals in their particular area. A zip code based search is performed in order to provide the current local deals that are being hosted by the social business network. By performing a zip code based search, a customer can easily find all deals that are available in his or her local area. This not only helps the consumers to find the most matched deals, but also helps the local businesses advertise and market to the people who are most likely to buy their products.

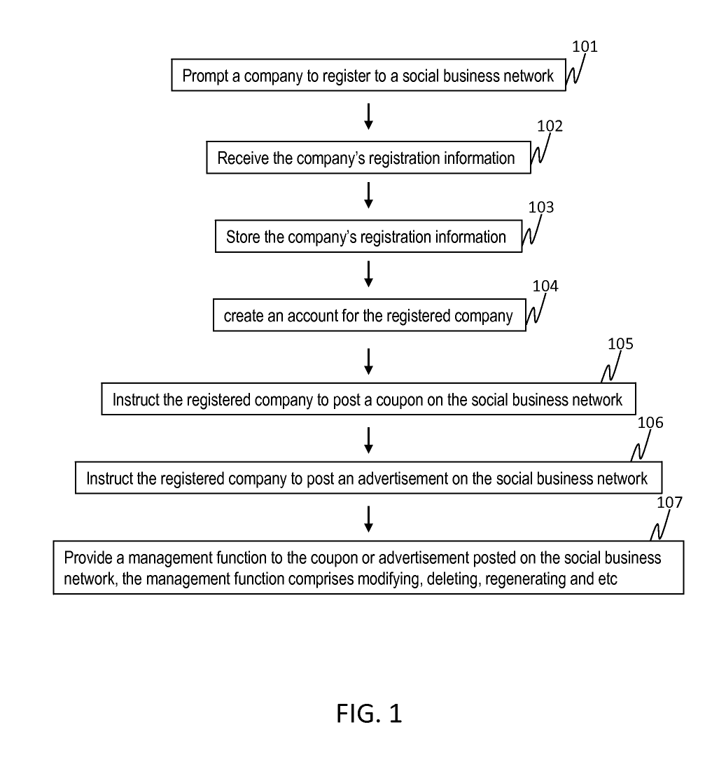

The social baseness network of the present invention has provided a valuable platform for a business to advertise and market their products and services. In order to utilize this social business network, a company must register to it first. In reference to FIG. 1, a company needs to register with the social business network 101. After receive the company's registration information 102, such information will be firstly saved on the database of the social business network 103 and then a new account with be created for the registered company 104. Following a successful registration, the company is now able to post its advertisements 106 or coupons 105 on the social business network under the prompts and instructions of the social business network. In addition to the foregoing, a registered company can also manage the contents it posted on the social business network, including adding, moving, deleting, modifying, regenerating and so on 107.

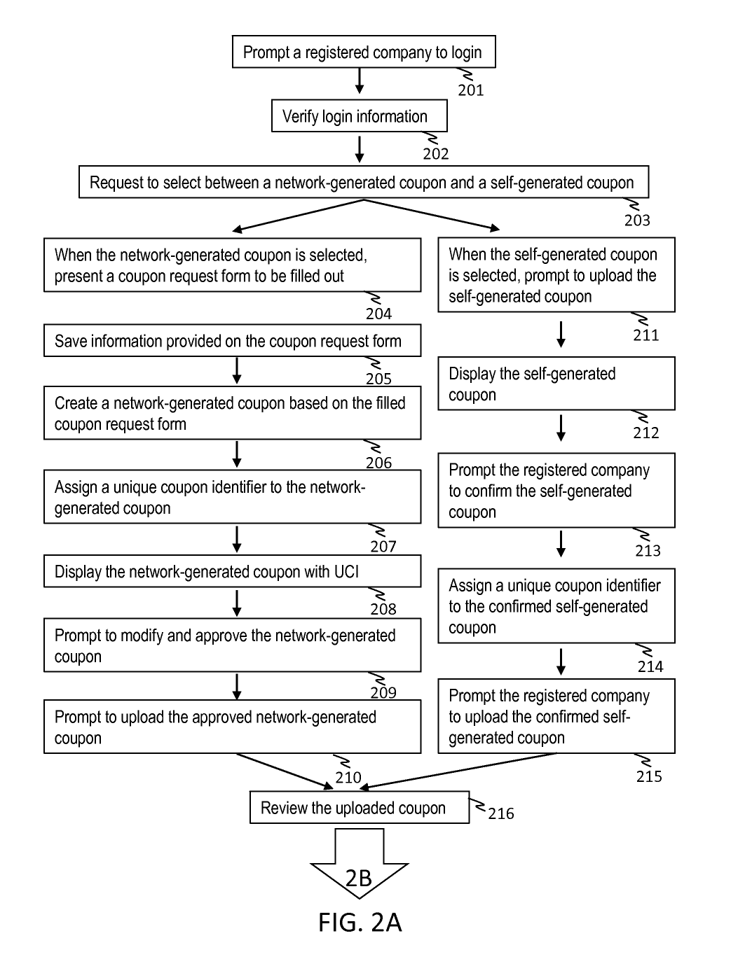

More specifically, in order to post its coupon on the social business network, a registered company needs to follow the procedures set forth below. In reference to FIG. 2, only the registered companies can post their coupons on the social business network. Generally, there are two methods whereby a registered company can post its coupon. One is that the company generates the coupon by itself, which is called the self-generated coupon. In this way, it only needs to upload it and post it on the social business network. The other one is that the registered company requests the social business network to generate a personalized coupon for it, which is called the network-generated coupon. This is particular convenient for the small businesses, as they only need to provide the content of the coupon, and do not need to worry about the design (font, color, and etc) and necessary legal terms and languages about the coupon.

Accordingly, the first step would be requesting the company to login 201, and then verify the login information 202, so as to make sure that only the registered companies can use the social business website to post coupons or advertisements. Following the verification, the logged company will be requested to make a selection between the aforementioned two methods to post a coupon on the social business website, i.e., selection between the network-generated coupon and the self-generated coupon 203. If the method of network-generated coupon is selected, then the registered company will be requested to fill out a coupon request form, in order to collect all of the necessary information for generating a network-generated coupon. Accordingly, a blank coupon request form is presented 204 to the company, and the letter will fill out the form by inputting all the information asked. The requested information comprises the item (product or service) for sale, discount level, valid location, valid time period, and desired ethnicity. The information provided by the company will be first saved 205, and then a new network-generated coupon will be generated based on the information provided on the coupon request form 206. And meanwhile, a unique coupon identifier will be assigned to the newly generated coupon 207. Next, the newly generated coupon will be presented (displayed) to the company for approval 208. Before its approval, the company can still modify it 209. Upon approval, the company will be asked to upload the approved final version of the network-generated coupon 210.

On the other hand, if the method of self-generated coupon has been selected, the company will be asked to upload the coupon it has created 211. Upon receiving it, the uploaded coupon will be displayed 212 on the website for the company to view and confirm 213. Once it has been confirmed, the self-generated coupon will also be assigned a unique coupon identifier 214. The purpose of assigning the unique coupon identifier to each coupon to be posted on the social business network, no matter it is network-generated or self-generated by the company, is to provide an easy way to track, and authenticate every coupon posted on the social business network. Finally, the confirmed version of the self-generated coupon will also be uploaded to the network's website 215.

As described above, the final version of the coupon (self-generated or website-generated) has been uploaded to the network's website. In order to ensure that the content of each coupon posted on the social business network is appropriate, every newly uploaded coupon will be reviewed 216, before it can be posted to the social business network. Upon reviewing, if the content of the uploaded coupon is determined to be proper, it will be next posted to the social business network 218. Nevertheless, if the content of an uploaded coupon is deemed to be improper, the registered company who created or requested to create the coupon will be notified about it 217. Upon receiving the notice, the company has various options. It can either cancel it, or modify it and then goes to the step 203 in order to eventually post it on the social business of the present invention.

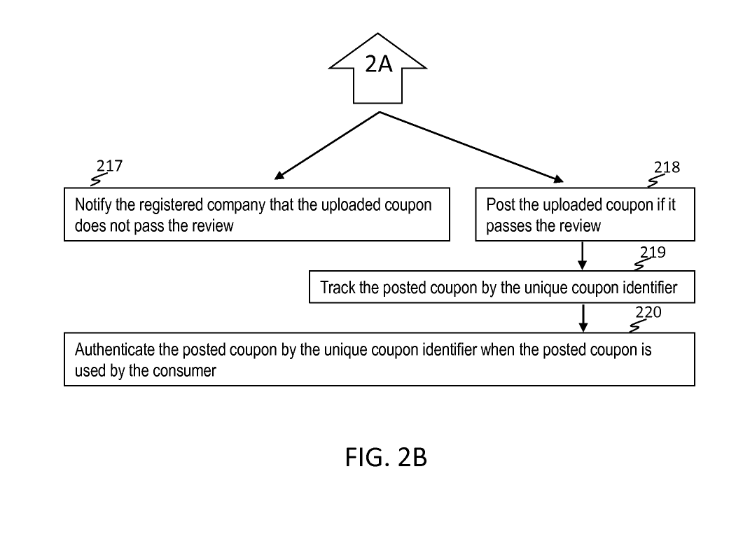

In addition to coupon, a company can also post its advertisements on the social business network. In reference to FIG. 3, similarly, only a registered company can do it. Therefore, a company will be requested to login beforehand 301. Following verification of the login information 302, the company will be requested to choose the type of the advertisement it wants to post on the network 303. The advertisement can take various forms, such as text, image, video and live feed. After the type of the advertisement has been set, an advertisement request form will be presented and the company will be requested to fill it out 304. This advertisement request form is similar to the coupon request form; it requires the information of company name, logo, advertisement text, advertisement file size, advertisement placement, advertisement duration and etc. upon receiving the information provided on the advertisement request form, such information will be saved 305. Next, the company will be prompted to a new webpage to make a payment for posting the advertisement on the social business network 307. Payment can then be made in any electronic format such as using a debit card, credit card, or PayPal account. A standard flat rate can be applied to advertisements or the rate can be varied depending on the type, size and placement of the advertisement 306. After making the payment, the company will be prompted to upload the advertisement 308. For the reason set forth previously, the uploaded advertisement will be reviewed prior to posting it to make sure it is appropriate to be posted on the network 309. In the case when it passes the review process, the advertisement will be posted on the social business network immediately 311. However, if the content of the advertisement is deemed to be improper, the company will be quickly notified about it 310. Then the company can either give up to post it on the network, or modify it and then try to post it again, starting from the step 303.

As mentioned above, a company needs to be registered firstly, before it can post coupons and advertisements on the social business network. In contrast, there is no any requirement for a consumer to search, view the posted coupons or advertisements. Unless otherwise required by a company who has posted it, each coupon or advertisement is made accessible to any consumer 401. There would be multiple ways that a consumer can get access to the coupons and advertisements posted on the network. A consumer may get access to the coupons and advertisements by connecting to the social business network. Any device that can be online may be used for this purpose, such as computer, mobile phone, tablet and etc. In addition, a consumer may be able to get access to the coupon or advertisement by scanning a quick response code 402.

Moreover, a consumer can also share a coupon with a friend or someone else by using the social business network of the present invention 403. The consumer can do it by virtue of email, short messaging, social media website and etc. In this way, more people will be able to get access to the coupons and advertisements by the form of word of mouth, which, to a potential purchaser, is somewhat more trustable and convincing than something heard from the vender directly.

Further, the social business network also provides multiple search functions to facilitate a consumer to find a coupon that he or she looks for. A consumer can conduct a search based on a particular location (such as zip code, city or town's name and etc) 404. Through this kind of search, a consumer is able to get access to all of the available coupons for a particular location. Also, a consumer is allowed to make an ethnicity based search 405. Each ethnicity has its own culture, traditional holiday, favorable cuisine and etc. Accordingly, the consumers of a particular ethnicity may need to continuously buy certain products or buy them in a large amount before a special holiday, while consumers of other ethnicities may not buy them at all. Therefore, organizing those coupons and advertisements for a particular ethnicity into a group and/or provide a search function for those ethnic products are the efficient ways to target those ethnic consumers. Especially in the U.S., almost everybody has its own ethnic tradition, Indian, Chinese, Jew, Hispanic, Scotsman, and so on. The combination of the multiple ethnic markets is comparable to such main market. Besides, the social business network of the present invention also provides certain advanced searches, which may be based on product or service category, discount level, item price, offer type and etc 406.

The found coupon(s) will be displayed to the consumer. If such coupon has a unique coupon identifier, such unique coupon identifier will also be provided to the consumer 407. At the same time, for the found coupon or any other coupon that the consumer is interested in, he can copy, download, and print it. If certain coupons need to be purchased, a consumer can buy it directly from the social business network 408. When a user accesses a coupon, the specific coupon information is displayed along with the unique coupon identifier and at least one button used to share the coupon which is located at the bottom of the coupon. Clicking the scissor icon next to the unique coupon identifier allows the unique coupon identifier to quickly and easily be copied. By clicking on the share button a pop-up window containing methods through which the coupon can be shared is opened. In this way coupons can be shared among users via a short messaging service, email, social media website or other suitable means of sharing information electronically. Some methods may require personal information to be submitted in order to share the coupon such as a phone number, email address or login information for a website. In certain cases when a coupon is actually offered by a third party website, a link (clickable link) will be provided to the consumer who can next go to the third party website via such link 409.

In addition to the coupons and advertisements that a registered company can post on the social business network, the network also provides other very useful functions for the company to market its product or service to consumers directly. One main such function would be the live video screen on the network 501. The live video screen can be located on the homepage of the social business network or it can be located on a separate page. A registered company can rent (by a time slot) of the live video screen 502. The live video screen is also provided with a live messaging box, through which the representative of the company can chat with consumers in real time. After a registered company has purchase certain time slot(s), such purchase information will be saved in the database 503. The live video screen is made available to the company purchased it within the purchased timeslot 504. By using the live video screen, a company can market its product or service to the consumer directly and in real time. They are able to interact with the consumers in real time through the live video screen in various forms, such as live conference, live seminar, live training program, live demonstration, live sale and so on 505. The live video screen may also be used for live or recorded conference or seminar; as well as the live or recorded training. Moreover, a company could purchase a time slot to use the live video screen. They could then provide real time product demonstrations to customers followed by real time sales. A live messaging box can be included with the live video screen such that customers are able to communicate and ask questions about a product during live demonstrations.

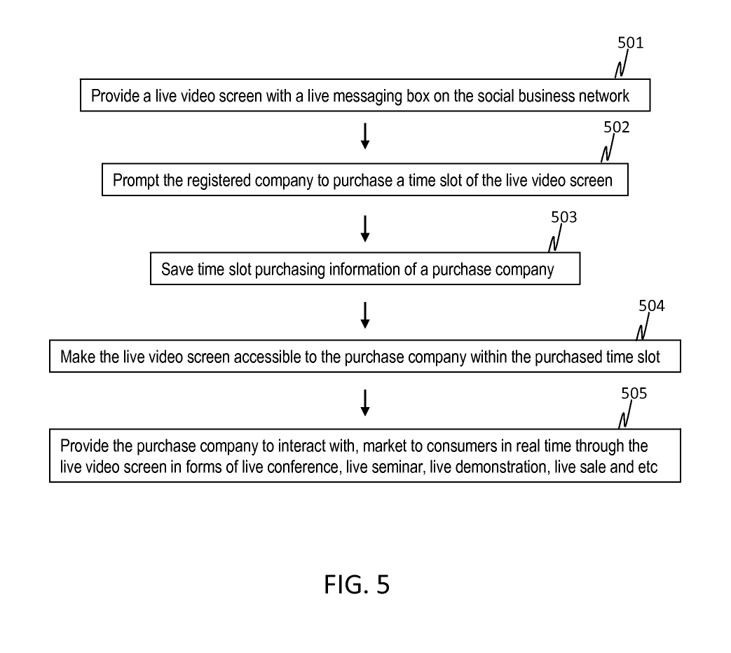

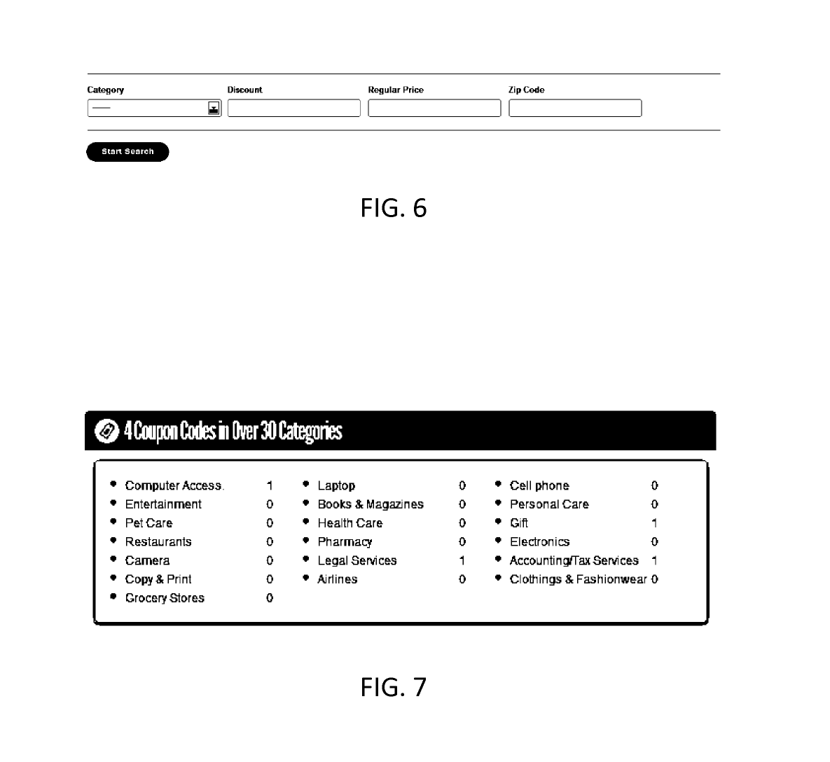

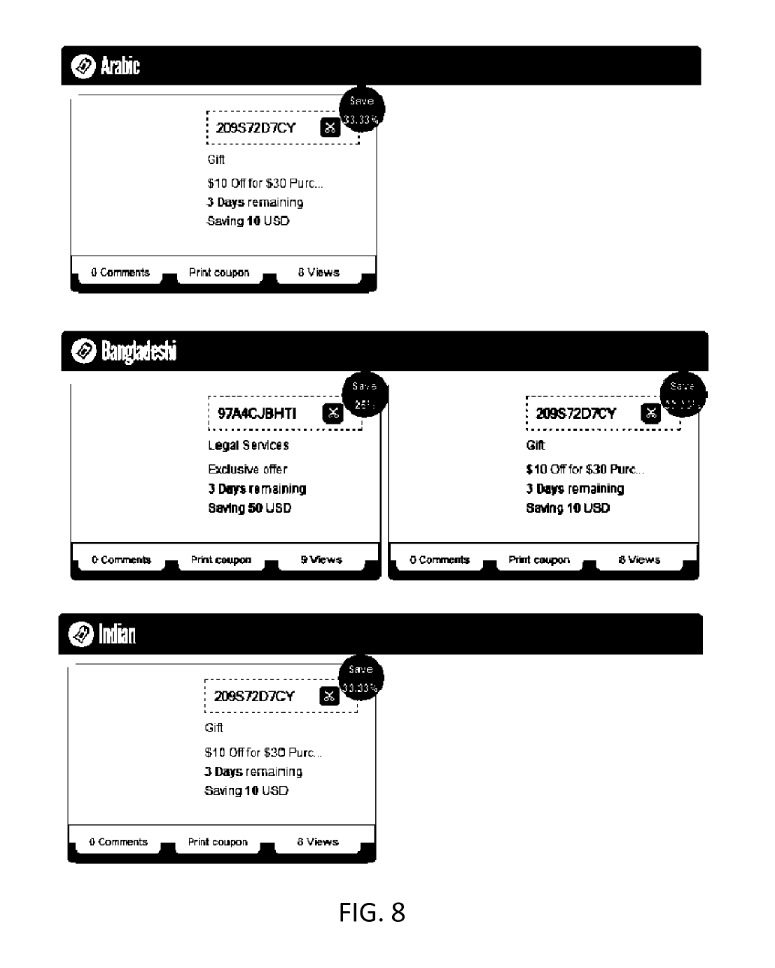

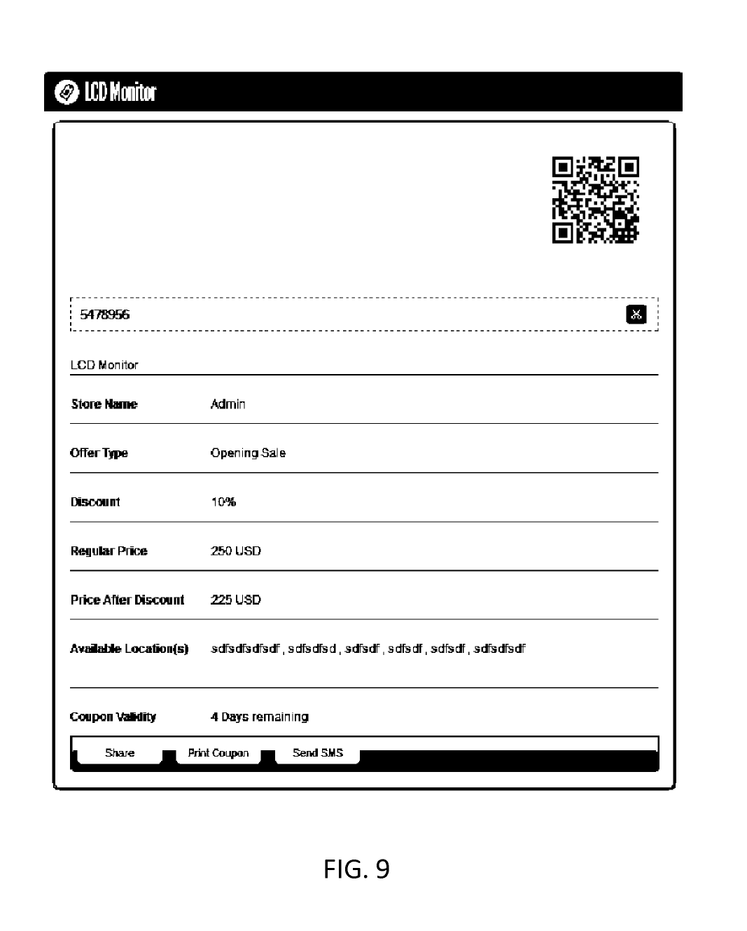

The method of using a social business network to market to certain consumers as disclosed in the present invention may take various forms. The embodiments of the present invention have also been shown in FIGS. 6-9. FIG. 6 shows the advanced search options that can be used to view coupons. In FIG. 7, it demonstrates that multiple product and service categories have been provided on the social business network. FIG. 8 shows certain examples of the search function of the social business network. In FIG. 8, a search is conducted based on ethnicities. FIG. 9 shows an example of a coupon (network-generated coupon), which is created based on the information provided from a filled out coupon request form. In addition, the Mobile Apps for Android and Apple devices are also available. Since this is a continuously evolving platform things will be modified/upgraded and added to.

Although the invention has been explained in relation to its preferred embodiment, it is to be understood that many other possible modifications and variations can be made without departing from the spirit and scope of the invention as herein described.

1. A non-transitory computer-readable medium that stores instructions executable by one or more processors to perform a method for providing marketing on a social business network, comprising
instructions for prompting a company to register to the social business network;
instructions for receiving registration information of the company;
instructions for saving the registration information;
instructions for creating an account for a registered company;
instructions for directing the registered company to post a coupon on the social business network;
instructions for directing the registered company to post an advertisement on the social business network; and
instructions for providing a management function for the coupon and advertisement posted on the social business network.

2. The non-transitory computer-readable medium that stores instructions executable by one or more processors to perform the method for providing marketing on a social business network as set forth in claim 1, wherein the management function comprising:
instructions for modifying the coupon and advertisement posted on the social business network;
instructions for deleting the coupon and advertisement posted on the social business network; and
instructions for regenerating the coupon and advertisement posted on the social business network.

3. The non-transitory computer-readable medium that stores instructions executable by one or more processors to perform the method for providing marketing on a social business network as set forth in claim 1, comprising:
instructions for prompting the registered company to login;
instructions for verifying login information; and
instructions for requesting to select a coupon generation method, wherein the coupon generation method comprises a method of network-generated coupon and a method of self-generated coupon.

4. The non-transitory computer-readable medium that stores instructions executable by one or more processors to perform the method for providing marketing on a social business network as set forth in claim 3, comprising:
instructions for presenting a coupon request form, when the method of network-generated coupon is selected;
instructions for directing the registered company to fill out the coupon request form;
instructions for saving information provided on the coupon request form;
instructions for creating a network-generated coupon based on the information provided on the coupon request form;
instructions for assigning a unique coupon identifier to the network-generated coupon;
instructions for displaying the network-generated coupon, along with the unique coupon identifier;
instructions for prompting to modify the network-generated coupon;
instructions for prompting to approve the network-generated coupon;
instructions for prompting to upload an approved network-generated coupon;
instructions for reviewing an uploaded coupon; and
instructions for notifying the registered company if the uploaded coupon does not pass the review, or
instructions for posting the uploaded coupon on the social business network if the uploaded coupon passes the review,
instructions for tracking a posted coupon by its unique coupon identifier, and
instructions for authenticating the posted coupon by its unique coupon identifier when the posted coupon is used by a consumer.

5. The non-transitory computer-readable medium that stores instructions executable by one or more processors to perform the method for providing marketing on a social business network as set forth in claim 4, wherein the coupon request form comprising:
item for sale, discount level, valid location, valid time period and desired ethnicity.

6. The non-transitory computer-readable medium that stores instructions executable by one or more processors to perform the method for providing marketing on a social business network as set forth in claim 3, comprising:
instructions for prompting to upload a self-generated coupon, when the method of self-generated coupon is selected;
instructions for displaying the self-generated coupon;
instructions for prompting the registered company to confirm the self-generated coupon as displayed;
instructions for assigning a unique coupon identifier to a confirmed self-generated coupon; and
instructions for prompting to uploaded the confirmed self-generated coupon.

7. The non-transitory computer-readable medium that stores instructions executable by one or more processors to perform the method for providing marketing on a social business network as set forth in claim 6, comprising:
instructions for reviewing an uploaded coupon; and
instructions for notifying the registered company if the uploaded coupon does not pass the review, or
instructions for posting the uploaded coupon on the social business network if the uploaded coupon passes the review, \instructions for tracking a posted coupon by its unique coupon identifier,
instructions for authenticating the posted coupon by its unique coupon identifier when the posted coupon is used by a consumer.

8. The non-transitory computer-readable medium that stores instructions executable by one or more processors to perform the method for providing marketing on a social business network as set forth in claim 1, comprising:
instructions for prompting the registered company to login;
instructions for verifying login information;
instructions for requesting to select an advertisement type, wherein the type comprises text, image, video and live feed;
instructions for presenting an advertisement request form;
instructions for directing the registered company to fill out the advertisement request form;
instructions for saving information provided on the advertisement request form;
instructions for determining a payment according to the information provided on the advertisement request form;
instructions for prompting the registered company to make the payment;
instructions for prompting to upload an advertisement, after the payment has been made;
instructions for reviewing an uploaded advertisement; and
instructions for notifying the registered company, if the uploaded advertisement does not pass the review, or
instructions for posting the uploaded advertisement on the social business network, if the uploaded advertisement passes the review.

9. The non-transitory computer-readable medium that stores instructions executable by one or more processors to perform the method for providing marketing on a social business network as set forth in claim 8, wherein the advertisement request form comprising:
company name and logo, advertisement text, advertisement file size, advertisement placement, and advertisement duration.

10. The non-transitory computer-readable medium that stores instructions executable by one or more processors to perform the method for providing marketing on a social business network as set forth in claim 1, comprising:
instructions for making coupons and advertisements posted on the social business network accessible to consumers;
instructions for allowing the consumers to access the coupons and advertisements with a device, wherein the device comprises computer, mobile phone and tablet computer;
instructions for allowing the consumers to access the coupons and advertisements by scanning quick response codes;
instructions for providing a function to share the coupons and advertisements;
instructions for providing a location based search for a coupon or advertisement;
instructions for providing an ethnicity based search for a coupon;
instructions for providing an advanced search for a coupon based on product or service category, discount level, item price and offer type;
instructions for displaying a found coupon;
instructions for providing functions of copying, downloading, printing and purchasing the found coupon; and
instructions for providing a link to a third party website, when the found coupon is offered on the third party website.

11. The non-transitory computer-readable medium that stores instructions executable by one or more processors to perform the method for providing marketing on a social business network as set forth in claim 1, comprising:
instructions for providing a live video screen on the social business network, wherein the live video screen comprises a live messaging box;
instructions for prompting the registered company to purchase a time slot for using the live video screen;
instructions for saving information of time slot purchased and information of purchasing company;
instructions for making the live video screen available to the purchasing company within the time slot purchased;
instructions for providing the purchasing company to interact and market to consumers in real time via the live video screen;
instructions for providing live or recorded conference or seminar via the live video screen; and
instructions for providing live or recorded training via the live video screen.

12. A non-transitory computer-readable medium that stores instructions executable by one or more processors to perform a method for providing marketing on a social business network, comprising
instructions for prompting a company to register to the social business network;
instructions for receiving registration information of the company;
instructions for saving the registration information;
instructions for creating an account for a registered company;
instructions for directing the registered company to post a coupon on the social business network;
instructions for directing the registered company to post an advertisement on the social business network;
instructions for providing a management function for the coupon and advertisement posted on the social business network, wherein the management function comprising
instructions for modifying the coupon and advertisement posted on the social business network,
instructions for deleting the coupon and advertisement posted on the social business network,
instructions for regenerating the coupon and advertisement posted on the social business network,
instructions for prompting the registered company to login;
instructions for verifying login information; and
instructions for requesting to select a coupon generation method, wherein the coupon generation method comprises a method of network-generated coupon and a method of self-generated coupon.

13. The non-transitory computer-readable medium that stores instructions executable by one or more processors to perform the method for providing marketing on a social business network as set forth in claim 12, comprising:
instructions for presenting a coupon request form, when the method of network-generated coupon is selected, wherein the coupon request form comprises item for sale, discount level, valid location, valid time period and desired ethnicity;
instructions for directing the registered company to fill out the coupon request form;
instructions for saving information provided on the coupon request form;
instructions for creating a network-generated coupon based on the information provided on the coupon request form;
instructions for assigning a unique coupon identifier to the network-generated coupon;
instructions for displaying the network-generated coupon, along with the unique coupon identifier;
instructions for prompting to modify the network-generated coupon;
instructions for prompting to approve the network-generated coupon;
instructions for prompting to upload an approved network-generated coupon;
instructions for reviewing an uploaded coupon; and
instructions for notifying the registered company if the uploaded coupon does not pass the review, or
instructions for posting the uploaded coupon on the social business network if the uploaded coupon passes the review,
instructions for tracking a posted coupon by its unique coupon identifier,
instructions for authenticating the posted coupon by its unique coupon identifier when the posted coupon is used by a consumer.

14. The non-transitory computer-readable medium that stores instructions executable by one or more processors to perform the method for providing marketing on a social business network as set forth in claim 12, comprising:
instructions for prompting to upload a self-generated coupon, when the method of self-generated coupon is selected;
instructions for displaying the self-generated coupon;
instructions for prompting the registered company to confirm the self-generated coupon as displayed;
instructions for assigning a unique coupon identifier to a confirmed self-generated coupon;
instructions for prompting to uploaded the confirmed self-generated coupon;
instructions for reviewing an uploaded coupon; and
instructions for notifying the registered company if the uploaded coupon does not pass the review, or
instructions for posting the uploaded coupon on the social business network if the uploaded coupon passes the review,
instructions for tracking a posted coupon by its unique coupon identifier,
instructions for authenticating the posted coupon by its unique coupon identifier when the posted coupon is used by a consumer.

15. The non-transitory computer-readable medium that stores instructions executable by one or more processors to perform the method for providing marketing on a social business network as set forth in claim 12, comprising:
instructions for prompting the registered company to login;
instructions for verifying login information;
instructions for requesting to select an advertisement type, wherein the type comprises text, image, video and live feed;
instructions for presenting an advertisement request form, wherein the advertisement request form comprises company name and logo, advertisement text, advertisement file size, advertisement placement, and advertisement duration;
instructions for directing the registered company to fill out the advertisement request form;
instructions for saving information provided on the advertisement request form;
instructions for determining a payment according to the information provided on the advertisement request form;
instructions for prompting the registered company to make the payment;
instructions for prompting to upload an advertisement, after the payment has been made;
instructions for reviewing an uploaded advertisement; and
instructions for notifying the registered company, if the uploaded advertisement does not pass the review, or
instructions for posting the uploaded advertisement on the social business network, if the uploaded advertisement passes the review.

16. The non-transitory computer-readable medium that stores instructions executable by one or more processors to perform the method for providing marketing on a social business network as set forth in claim 12, comprising:
instructions for making coupons and advertisements posted on the social business network accessible to consumers;
instructions for allowing the consumers to access the coupons and advertisements with a device, wherein the device comprises computer, mobile phone and tablet computer;
instructions for allowing the consumers to access the coupons and advertisements by scanning quick response codes;
instructions for providing a function to share the coupons and advertisements;
instructions for providing a location based search for a coupon or advertisement;
instructions for providing an ethnicity based search for a coupon;
instructions for providing an advanced search for a coupon based on product or service category, discount level, item price and offer type;
instructions for displaying a found coupon;
instructions for providing functions of copying, downloading, printing and purchasing the found coupon; and
instructions for providing a link to a third party website, when the found coupon is offered on the third party website.

17. The non-transitory computer-readable medium that stores instructions executable by one or more processors to perform the method for providing marketing on a social business network as set forth in claim 12, comprising:
instructions for providing a live video screen on the social business network, wherein the live video screen comprises a live messaging box;
instructions for prompting the registered company to purchase a time slot for using the live video screen;
instructions for saving information of time slot purchased and information of purchasing company;
instructions for making the live video screen available to the purchasing company within the time slot purchased;
instructions for providing the purchasing company to interact and market to consumers in real time via the live video screen;
instructions for providing live or recorded conference or seminar via the live video screen; and
instructions for providing live or recorded training via the live video screen.

18. A non-transitory computer-readable medium that stores instructions executable by one or more processors to perform a method for providing marketing on a social business network, comprising
instructions for prompting a company to register to the social business network;
instructions for receiving registration information of the company;
instructions for saving the registration information;
instructions for creating an account for a registered company;
instructions for directing the registered company to post a coupon on the social business network;
instructions for directing the registered company to post an advertisement on the social business network;
instructions for providing a management function for the coupon and advertisement posted on the social business network, wherein the management function comprising
instructions for modifying the coupon and advertisement posted on the social business network,
instructions for deleting the coupon and advertisement posted on the social business network,
instructions for regenerating the coupon and advertisement posted on the social business network,
instructions for prompting the registered company to login;
instructions for verifying login information;
instructions for requesting to select a coupon generation method, wherein the coupon generation method comprises a method of network-generated coupon and a method of self-generated coupon;
instructions for presenting a coupon request form, when the method of network-generated coupon is selected, wherein the coupon request form comprises item for sale, discount level, valid location, valid time period and desired ethnicity;
instructions for directing the registered company to fill out the coupon request form;
instructions for saving information provided on the coupon request form;
instructions for creating a network-generated coupon based on the information provided on the coupon request form;
instructions for assigning a unique coupon identifier to the network-generated coupon;
instructions for displaying the network-generated coupon, along with the unique coupon identifier;
instructions for prompting to modify the network-generated coupon;
instructions for prompting to approve the network-generated coupon;
instructions for prompting to upload an approved network-generated coupon;
instructions for prompting to upload a self-generated coupon, when the method of self-generated coupon is selected;
instructions for displaying the self-generated coupon;
instructions for prompting the registered company to confirm the self-generated coupon as displayed;
instructions for assigning a unique coupon identifier to a confirmed self-generated coupon;
instructions for prompting to uploaded the confirmed self-generated coupon;
instructions for reviewing an uploaded coupon; and
instructions for notifying the registered company if the uploaded coupon does not pass the review, or
instructions for posting the uploaded coupon on the social business network if the uploaded coupon passes the review,
instructions for tracking a posted coupon by its unique coupon identifier,
instructions for authenticating the posted coupon by its unique coupon identifier when the posted coupon is used by a consumer.

19. The non-transitory computer-readable medium that stores instructions executable by one or more processors to perform the method for providing marketing on a social business network as set forth in claim 18, comprising:
instructions for prompting the registered company to login;
instructions for verifying login information;
instructions for requesting to select an advertisement type, wherein the type comprises text, image, video and live feed;
instructions for presenting an advertisement request form, wherein the advertisement request form comprises company name and logo, advertisement text, advertisement file size, advertisement placement, and advertisement duration;
instructions for directing the registered company to fill out the advertisement request form;
instructions for saving information provided on the advertisement request form;
instructions for determining a payment according to the information provided on the advertisement request form;
instructions for prompting the registered company to make the payment;
instructions for prompting to upload an advertisement, after the payment has been made;
instructions for reviewing an uploaded advertisement; and
instructions for notifying the registered company, if the uploaded advertisement does not pass the review, or
instructions for posting the uploaded advertisement on the social business network, if the uploaded advertisement passes the review.

20. The non-transitory computer-readable medium that stores instructions executable by one or more processors to perform the method for providing marketing on a social business network as set forth in claim 18, comprising:
instructions for making coupons and advertisements posted on the social business network accessible to consumers;
instructions for allowing the consumers to access the coupons and advertisements with a device, wherein the device comprises computer, mobile phone and tablet computer;
instructions for allowing the consumers to access the coupons and advertisements by scanning quick response codes;
instructions for providing a function to share the coupons and advertisements;
instructions for providing a location based search for a coupon or advertisement;
instructions for providing an ethnicity based search for a coupon;
instructions for providing an advanced search for a coupon based on product or service category, discount level, item price and offer type;
instructions for displaying a found coupon;
instructions for providing functions of copying, downloading, printing and purchasing the found coupon;
instructions for providing a link to a third party website, when the found coupon is offered on the third party website;
instructions for providing a live video screen on the social business network, wherein the live video screen comprises a live messaging box;
instructions for prompting the registered company to purchase a time slot for using the live video screen;
instructions for saving information of time slot purchased and information of purchasing company;
instructions for making the live video screen available to the purchasing company within the time slot purchased;
instructions for providing the purchasing company to interact and market to consumers in real time via the live video screen;
instructions for providing live or recorded conference or seminar via the live video screen; and
instructions for providing live or recorded training via the live video screen.
